(19) United States
(12) Patent Application Publication
(10) Pub. No.: US 2026/0360924 A1
(43) Pub. Date: Nov. 12, 2026

(54) SECONDARY BATTERY

(71) Applicant: Panasonic Intellectual Property Management Co., Ltd., Kadoma-shi, Osaka (JP)

(72) Inventors: Shohei Kusumoto, Osaka (JP); Keiko Kato, Aichi (JP); Takuya Iwamoto, Osaka (JP); Hajime Nishino, Nara (JP)

(73) Assignee: Panasonic Intellectual Property Management Co., Ltd., Kadoma-shi, Osaka (JP)

(21) Appl. No.: 19/125,928

(22) PCT Filed: Nov. 9, 2023
(86) PCT No.: PCT/JP2023/040382

§ 371 Date: Apr. 30, 2025

(30) Foreign Application Priority Data
Nov. 22, 2022 (JP) 2022-186368

(51) Int. Cl. H01M 50/46; H01M 50/489; H01M 50/50

(52) U.S. Cl. CPC H01M 50/46; H01M 50/489; H01M 50/50

(57) ABSTRACT

A secondary battery according to this disclosure comprises a positive electrode, a negative electrode, and a separator provided between the positive electrode and the negative electrode. The positive electrode has a positive electrode current collector and a positive electrode composite layer disposed on the positive electrode current collector. The negative electrode has a negative electrode current collector and a negative electrode composite layer disposed on the negative electrode current collector. The negative electrode composite layer has a negative electrode active material including a Si-containing material. The positive electrode current collector and/or the negative electrode current collector satisfy the relationship CM×CT≤1700, the 1% elongation strength of the current collector being CM (MPa) and the average thickness of the current collector being CT (μm). A first separator surface and/or a second separator surface of the separator have a ten-point average roughness (Rz) of 2.7 μm or greater.

### TECHNICAL FIELD

The present disclosure relates to a secondary battery.

### BACKGROUND

In recent years, as a secondary battery having high output and high energy density, a secondary battery such as a lithium-ion secondary battery including an electrode assembly in which a positive electrode and a negative electrode are arranged to face each other with a separator interposed therebetween has been widely used.

The secondary battery such as the lithium-ion secondary battery has been used as a power supply for a wide range of devices including electric vehicles, and a further increase in capacity has been required. For example, Patent Literature 1 discloses that a Si-containing material is used as a negative electrode active material in order to increase the capacity of a secondary battery.

### CITATION LIST

### Patent Literature

Patent Literature 1: WO 2016-035290 A

### SUMMARY

Incidentally, since the Si-containing material has a large volume change (expansion/contraction) during charging and discharging, the electrode assembly may be buckled according to charging and discharging. Further, a current collector used for the positive electrode and the negative electrode may be damaged, and the battery resistance may be increased.

Therefore, an object of the present disclosure is to suppress occurrence of buckling of an electrode assembly and suppress an increase in battery resistance, in a secondary battery using a Si-containing material as a negative electrode active material.

A secondary battery according to the present disclosure includes an electrode assembly having a positive electrode, a negative electrode, and a separator provided between the positive electrode and the negative electrode. The positive electrode has a positive electrode current collector and a positive electrode mixture layer disposed on the positive electrode current collector. The negative electrode has a negative electrode current collector and a negative electrode mixture layer disposed on the negative electrode current collector. The negative electrode mixture layer has a negative electrode active material including a Si-containing material. At least one of the positive electrode current collector and the negative electrode current collector satisfies a relationship CM×CT≤1700, the 1% elongation strength of the current collector being CM (MPa) and the average thickness of the current collector being CT (μm). The separator has a first separator surface facing the positive electrode and a second separator surface facing the negative electrode, and at least one of the first separator surface and the second separator surface has a ten-point average roughness (Rz) of greater than or equal to 2.7 μm.

According to the present disclosure, in a secondary battery using a Si-containing material as a negative electrode active material, occurrence of buckling of an electrode assembly can be suppressed, and an increase in battery resistance can be suppressed.

### BRIEF DESCRIPTION OF DRAWINGS

FIG. 1 is a cross-sectional view of a secondary battery according to an example of an embodiment.

FIG. 2 is a schematic view illustrating a state in which a separator is disposed between a positive electrode and a negative electrode.

FIG. 3 is a schematic cross-sectional view illustrating an example of the separator according to the present embodiment.

### DESCRIPTION OF EMBODIMENTS

A secondary battery according to an aspect of the present disclosure includes an electrode assembly having a positive electrode, a negative electrode, and a separator provided between the positive electrode and the negative electrode. The positive electrode has a positive electrode current collector and a positive electrode mixture layer disposed on the positive electrode current collector. The negative electrode has a negative electrode current collector and a negative electrode mixture layer disposed on the negative electrode current collector. The negative electrode mixture layer has a negative electrode active material including a Si-containing material. At least one of the positive electrode current collector and the negative electrode current collector satisfies a relationship CM×CT≤1700, the 1% elongation strength of the current collector being CM (MPa) and the average thickness of the current collector being CT (μm). The separator has a first separator surface facing the positive electrode and a second separator surface facing the negative electrode, and at least one of the first separator surface and the second separator surface has a ten-point average roughness (Rz) of greater than or equal to 2.7 μm.

The present inventors have extensively conducted studies, and resultantly found that when a current collector satisfying a relationship of CM×CT≤1700 is used, buckling of an electrode assembly according to charging and discharging of a battery is suppressed. In addition, it has also been found that by using a separator having a surface having a ten-point average roughness (Rz) of greater than or equal to 2.7 μm, damage to the current collector is suppressed, so that an increase in battery resistance is suppressed. Although this mechanism is not clear, it is considered that the current collector satisfying the relationship of CM×CT≤1700 has appropriate flexibility, and the current collector follows a volume change of a Si-containing material during charging and discharging, so that buckling of the electrode assembly is suppressed. When stress due to the volume change of the Si-containing material is applied to the current collector satisfying the relationship of CM×CT≤1700 during a long period, the current collector may be damaged. However, it is considered that by using a separator having a surface having a ten-point average roughness (Rz) of greater than or equal to 2.7 μm, an appropriate space is formed in the electrode assembly, and therefore the stress applied to the current collector due to the volume change of the Si-containing material during charging and discharging is relaxed. Therefore, it is considered that damage to the current collector is suppressed, leading to suppression of an increase in battery resistance.

Hereinafter, an example of an embodiment of a secondary battery according to the present disclosure will be described in detail.

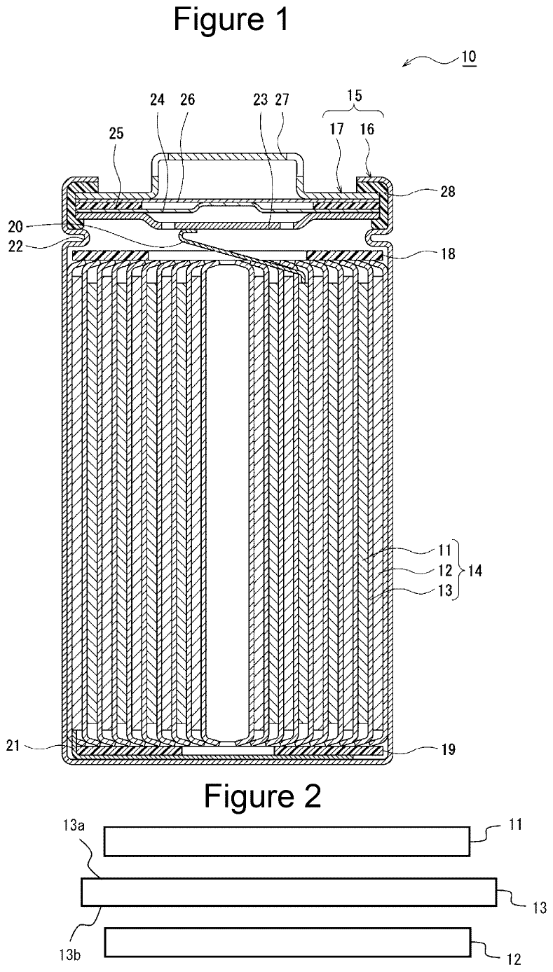

FIG. 1 is a cross-sectional view of a secondary battery of an example of an embodiment. A secondary battery 10 illustrated in FIG. 1 includes a wound electrode assembly 14 in which a positive electrode 11 and a negative electrode 12 are wound with a separator 13 interposed therebetween, a non-aqueous electrolyte, insulating plates 18 and 19 disposed on the upper and lower sides of the electrode assembly 14 respectively, and a battery case 15 housing the above-described members. The battery case 15 includes a bottomed cylindrical case body 16 and a sealing assembly 17 that seals an opening of the case body 16. Note that, instead of the wound electrode assembly 14, an electrode assembly having another form, such as a stacked electrode assembly in which positive electrodes and negative electrodes are alternately stacked with separators interposed therebetween, may be applied. Furthermore, examples of the battery case 15 include metal cases having a cylindrical shape, a square shape, a coin shape, a button shape, or the like, and resin cases formed by laminating resin sheets (so-called laminate type).

The non-aqueous electrolyte has, for example, ion conductivity (for example, lithium ion conductivity). The non-aqueous electrolyte may be a liquid electrolyte (electrolytic solution) or a solid electrolyte.

The liquid electrolyte (electrolytic solution) contains, for example, a non-aqueous solvent and an electrolyte salt dissolved in the non-aqueous solvent. Examples of the non-aqueous solvent include esters, ethers, nitriles, amides, and mixed solvents of two or greater thereof. Examples of the non-aqueous solvent include ethylene carbonate (EC), ethyl methyl carbonate (EMC), dimethyl carbonate (DMC), diethyl carbonate (DEC), and mixed solvents thereof. The non-aqueous solvent may contain a halogen-substituted product (for example, fluoroethylene carbonate or the like) in which at least a part of hydrogen in these solvents is substituted with a halogen atom such as fluorine. As the electrolyte salt, for example, a lithium salt such as LiPF₆ is used.

As the solid electrolyte, for example, a solid or gel polymer electrolyte, an inorganic solid electrolyte, or the like can be used. The polymer electrolyte contains, for example, a lithium salt and a matrix polymer or contains, for example, a non-aqueous solvent, a lithium salt, and a matrix polymer. As the matrix polymer, for example, a polymer material that absorbs a non-aqueous solvent and gelates is used. Examples of the polymer material include a fluororesin, an acrylic resin, and a polyether resin. As the inorganic solid electrolyte, for example, a material known for all-solid-state lithium-ion secondary batteries and the like (for example, an oxide-based solid electrolyte, a sulfide-based solid electrolyte, a halogen-based solid electrolyte, or the like) can be used. The non-aqueous electrolyte is an example, and may be an aqueous electrolyte as long as it is applicable.

The case body 16 is, for example, a bottomed cylindrical metal container. A gasket 28 is provided between the case body 16 and the sealing assembly 17 to ensure airtightness within the battery. The case body 16 has a projecting portion 22 in which, for example, a part of a side surface portion of the case body 16 projects inward to support the sealing assembly 17. The projecting portion 22 is preferably formed in an annular shape along the circumferential direction of the case body 16, and supports the sealing assembly 17 on its top surface.

The sealing assembly 17 has a structure in which a filter 23, a lower vent member 24, an insulating member 25, an upper vent member 26, and a cap 27 are sequentially stacked from the electrode assembly 14 side. Each member constituting the sealing assembly 17 has, for example, a disk shape or a ring shape, and the members excluding the insulating member 25 are electrically connected to each other. The lower vent member 24 and the upper vent member 26 are connected to each other at their central portions, and the insulating member 25 is interposed between the circumferential portions of the lower vent member 24 and the upper vent member 26. When the internal pressure of the secondary battery 10 increases due to heat generated by an internal short circuit or the like, for example, the lower vent member 24 deforms so as to push the upper vent member 26 up toward the cap 27 side and breaks, so that a current path between the lower vent member 24 and the upper vent member 26 is cut off. When the internal pressure further increases, the upper vent member 26 breaks, and gas is discharged from an opening of the cap 27.

In the secondary battery 10 illustrated in FIG. 1, a positive electrode lead 20 attached to the positive electrode 11 extends to the sealing assembly 17 side through a through hole of the insulating plate 18, and a negative electrode lead 21 attached to the negative electrode 12 extends to the bottom side of the case body 16 through the outside of the insulating plate 19. The positive electrode lead 20 is connected to a bottom surface of the filter 23, which is the bottom plate of the sealing assembly 17, by welding or the like, and the cap 27, which is electrically connected to the filter 23 and is the top plate of the sealing assembly 17, serves as a positive electrode terminal. The negative electrode lead 21 is connected to the bottom inner surface of the case body 16 by welding or the like, and the case body 16 serves as a negative electrode terminal.

Hereinafter, the positive electrode 11, the negative electrode 12, and the separator 13 will be described in detail.

### [Positive Electrode]

The positive electrode 11 includes a positive electrode current collector and a positive electrode mixture layer disposed on the positive electrode current collector. The positive electrode mixture layer may be disposed on only one surface or both surfaces of the positive electrode current collector. As the positive electrode current collector, a foil of a metal that is stable in a potential range of the positive electrode 11, such as aluminum, a film in which the metal is disposed on a surface layer thereof, or the like can be used. The 1% elongation strength and the average thickness of the positive electrode current collector will be described later.

The positive electrode mixture layer includes, for example, a positive electrode active material, a binder, and a conductive agent. The positive electrode 11 can be produced, for example, by applying a positive electrode mixture slurry containing the positive electrode active material, the binder, the conductive agent, and the like onto the positive electrode current collector, drying a coating film, and then rolling the coating film.

Examples of the positive electrode active material include lithium transition metal oxides containing transition metal elements such as Co, Mn, and Ni. Examples of the lithium transition metal oxides include LiₓCoO₂, LiₓNiO₂, LiₓMuO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMPO₄, and Li₂MPO₄F (M is at least one of Na, Mg, Sc, Y, Mn, Fe, Co, Ni, Cu, Zn, Al, Cr, Pb, Sb, and B, 0<x≤1.2, 0<y≤0.9, and 2.0≤z≤2.3). These may be used singly, or a plurality of kinds of them may be mixed and used. From the viewpoint that a high capacity of the secondary battery can be achieved, it is desirable that the positive electrode active material contains a lithium nickel composite oxide such as LiₓNiO₂, LiₓCo_{y}Ni_{1-y}O₂, or LiₓNi_{1-y}M_{y}O_{z} (M is at least one of Na, Mg, Sc, Y, Mn, Fe, Co, Ni, Cu, Zn, Al, Cr, Pb, Sb, and B, 0<x≤1.2, 0<y≤0.9, and 2.0≤z≤2.3).

Examples of the conductive agent include carbon particles such as carbon black (CB), acetylene black (AB), Ketjenblack, carbon nanotube (CNT), and graphite. These may be used singly or in combination of two or more kinds thereof.

Examples of the binder include fluorine-based resins such as polytetrafluoroethylene (PTFE) and polyvinylidene fluoride (PVDF), polyacrylonitrile (PAN), polyimide-based resins, acrylic resins, polyolefin-based resins, styrene-butadiene rubber (SBR), carboxymethyl cellulose (CMC) or salts thereof, polyacrylic acid (PAA) or salts thereof (PAA-Na, PAA-K, and the like, and partially neutralized salts may be used), and polyvinyl alcohol (PVA). These may be used singly or in combination of two or more kinds thereof.

### [Negative Electrode]

The negative electrode 12 includes a negative electrode current collector and a negative electrode mixture layer disposed on the negative electrode current collector. The negative electrode mixture layer may be disposed on only one surface or both surfaces of the negative electrode current collector. As the negative electrode current collector, a foil of a metal that is stable in a potential range of the negative electrode, such as copper or a copper alloy, a film in which the metal is disposed on a surface layer thereof, or the like can be used. The 1% elongation strength and the average thickness of the negative electrode current collector will be described later.

The negative electrode mixture layer includes, for example, a negative electrode active material, a binder, and a conductive agent. The negative electrode 12 can be produced, for example, by applying a negative electrode mixture slurry containing the negative electrode active material, the binder, and the like onto the negative electrode current collector, drying a coating film, and then rolling the coating film.

The negative electrode active material contains a Si-containing material. Examples of the Si-containing material include Si, a Si alloy, and a Si compound. In addition, the Si-containing material may be, for example, composite particles having an ion conducting phase and a silicon phase (silicon particles from one viewpoint) dispersed in the ion conducting phase. The ion conducting phase is a phase that conducts ions, and examples thereof include a silicate phase, a carbon phase, and a silicon oxide phase. The Si-containing material preferably includes, for example, at least one of first composite particles having a carbon phase and a silicon phase dispersed in the carbon phase, second composite particles having a silicate phase and a silicon phase dispersed in the silicate phase, and third composite particles having a silicon oxide phase and a silicon phase dispersed in the silicon oxide phase.

The carbon phase may be composed of, for example, amorphous carbon (amorphous carbon). Examples of the amorphous carbon constituting the carbon layer include hard carbon, soft carbon, and other amorphous carbon. The amorphous carbon is a carbon material in which an average spacing d₀₀₂ of (002) face measured by an X-ray diffraction method exceeds 0.34 nm.

A main component (for example, greater than or equal to 95 mass % and less than or equal to 100 mass %) of the silicon oxide phase may be silicon dioxide. The composition of the composite particle including the silicon oxide phase and the silicon phase dispersed therein can be represented by SiOₓ as a whole. SiOₓ has a structure in which silicon fine particles are dispersed in amorphous SiO₂. A content ratio x of oxygen to silicon is, for example, preferably 0.5≤x<2.0, and more preferably 0.8≤x≤1.5.

The silicate phase may satisfy the following conditions (1) and/or (2).
(1) The silicate phase contains at least one selected from the group consisting of an alkali metal element and a Group 2 element (Group 2 element of the long form of the periodic table).
(2) The silicate phase contains an element L. The element L is at least one selected from the group consisting of B, Al, Zr, Nb, Ta, V, lanthanoid, Y, Ti, P, Bi, Zn, Sn, Pb, Sb, Co, Er, F, and W. The lanthanoid is a generic term for 15 elements from lanthanum (La) with an atomic number 57 to lutetium (Lu) with an atomic number 71.

With regard to the condition (1), examples of the alkali metal element include lithium (Li), potassium (K), and sodium (Na). Examples of the Group 2 element include magnesium (Mg), calcium (Ca), strontium (Sr), and barium (Ba). By containing the alkali metal element and/or the Group 2 element, an irreversible capacity of the silicate phase may be reduced. The silicate phase (hereinafter, it may be referred to as a “lithium silicate phase”) containing lithium is preferable, for example, from the viewpoint of having a small irreversible capacity and high initial charging and discharging efficiency.

The lithium silicate phase may be an oxide phase containing Li, Si, and O, and may contain other elements. An atomic ratio of O to Si:O/Si in the lithium silicate phase is, for example, greater than 2 and less than 4. Preferably, O/Si is greater than 2 and less than 3. An atomic ratio of Li to Si:Li/Si in the lithium silicate phase is, for example, greater than 0 and less than 4.

The lithium silicate phase may include a lithium silicate phase represented by a formula: Li_{2z}SiO_{(2÷z)} (0<z<2), or may be composed of the lithium silicate phase. z preferably satisfies a relationship of 0<z<1, and is more preferably z=½ (that is, Li₂Si₂O₅).

The Si-containing material may include a composite particle containing an ion conducting phase and a silicon phase dispersed in the ion conducting phase, and a coating layer covering at least a part of a surface of the composite particle.

The coating layer present on the surface of the composite particle includes, for example, a conductive layer. By forming the conductive layer on the surface of the composite particle, the conductivity of the Si-containing material can be improved. As the conductive material constituting the conductive layer, a conductive material containing carbon is preferable. Examples of the conductive material containing carbon include a conductive carbon material. Examples of the conductive carbon material include carbon black, graphite, and amorphous carbon having low crystallinity (amorphous carbon). The amorphous carbon is preferable in that it has a large buffering action on the silicon phase that changes in volume by charging and discharging. The amorphous carbon may be easily graphitizable carbon (soft carbon) or hardly graphitizable carbon (hard carbon). Examples of the carbon black include acetylene black and Ketjenblack. The thickness of the conductive layer may be, for example, in a range of greater than or equal to 1 nm and less than or equal to 200 nm. The thickness of the conductive layer can be measured by observing a cross section of the Si-containing material using SEM or TEM (transmission electron microscope).

The content of the Si-containing material is, for example, preferably greater than or equal to 3 mass % with respect to the total mass of the negative electrode active material from the viewpoint of, for example, increasing the capacity of the battery. The upper limit of the content of the Si-containing material is preferably, for example, less than or equal to 20 mass %.

The negative electrode active material may contain, in addition to the Si-containing material, for example, a known material capable of reversibly storing and releasing lithium ions. The negative electrode active material preferably contains a carbon material from the viewpoints of further suppressing deterioration of charge-discharge cycle characteristics of the battery, for example. Examples of the carbon material include graphite materials such as natural graphite and artificial graphite. The content of the carbon material is preferably, for example, greater than or equal to 80 mass % with respect to the total mass of the negative electrode active material. In addition, the negative electrode active material may contain a Sn-containing material, a Ti-containing material, or the like as a known material capable of reversibly storing and releasing lithium ions.

Examples of the binder include fluorine-based resins such as polytetrafluoroethylene (PTFE) and polyvinylidene fluoride (PVDF), polyacrylonitrile (PAN), polyimide-based resins, acrylic resins, polyolefin-based resins, styrene-butadiene rubber (SBR), carboxymethyl cellulose (CMC) or salts thereof, polyacrylic acid (PAA) or salts thereof (PAA-Na, PAA-K, and the like, and partially neutralized salts may be used), and polyvinyl alcohol (PVA). These may be used singly or in combination of two or more kinds thereof.

Examples of the conductive agent include carbon particles such as carbon black (CB), acetylene black (AB), Ketjenblack, carbon nanotube (CNT), and graphite. These may be used singly or in combination of two or more kinds thereof.

[1% Elongation Strength CM (MPa) of Current Collector×Average Thickness CT (μm) of Current Collector]

For example, from the viewpoint of suppressing the occurrence of buckling of the electrode assembly 14, at least one of the positive electrode current collector and the negative electrode current collector has a 1% elongation strength CM (MPa) of the current collector and an average thickness CT (μm) of the current collector, which satisfy CM×CT≤1700, preferably 500≤CM×CT≤1700, and more preferably 870≤CM×CT≤1560. The 1% elongation strength CM of the current collector is a strength (1%) measured by a metal material tensile test method of JIS Z 2241. The 1% elongation strength CM of the current collector can be adjusted by, for example, the thickness of the current collector or the crystal particle diameter of the material of the current collector. The average thickness CT of the current collector is a value obtained by cutting the current collector along a plane perpendicular to a plane direction of the current collector, measuring the thickness at 10 or greater points in a cross section, and averaging the measured thicknesses.

The average thickness CT of the current collector in at least one of the positive electrode current collector and the negative electrode current collector is, for example, preferably greater than or equal to 5.0 μm and less than or equal to 25.0 μm, and more preferably greater than or equal to 7.8 μm and less than or equal to 15.0 μm from the viewpoint of suppressing the occurrence of buckling of the electrode assembly 14. In addition, the 1% elongation strength CM of the current collector in at least one of the positive electrode current collector and the negative electrode current collector is, for example, preferably greater than or equal to 50 MPa and less than or equal to 300 MPa, and more preferably greater than or equal to 58 MPa and less than or equal to 200 MPa from the viewpoint of suppressing the occurrence of buckling of the electrode assembly 14.

### [Separator]

FIG. 2 is a schematic view illustrating a state in which the separator is disposed between the positive electrode and the negative electrode. The positive electrode 11, the negative electrode 12, and the separator 13 illustrated in FIG. 2 are in a state before winding. The electrode assembly 14 is formed by winding the positive electrode 11 and the negative electrode 12 with the separator 13 interposed therebetween. In FIG. 2, a gap between the positive electrode 11 and the separator 13, and a gap between the negative electrode 12 and the separator 13 are exaggerated.

The separator 13 has a first separator surface 13a facing the positive electrode 11 and a second separator surface 13b facing the negative electrode 12. At least one of the first separator surface 13a and the second separator surface 13b has a ten-point average roughness (Rz) of greater than or equal to 2.7 μm. The ten-point average roughness (Rz) refers to a value obtained by extracting only a reference length from a roughness curve in a direction of an average line thereof, calculating the sum of an average value of absolute values of the altitudes (Yp) of peaks from a highest peak to a fifth peak and an average value of absolute values of the altitudes (Yv) of valleys from a lowest valley to a fifth valley, measured in a direction of a longitudinal magnification from the average line of the extracted portion, and representing this value in micrometers (μm). The larger the value of the ten-point average roughness (Rz), the coarser the surface of the separator as a whole, and the smaller the value of the ten-point average roughness (Rz), the smoother the surface of the separator as a whole. For example, the surface of the separator is observed with a laser microscope (OLYMPUS OLS4100, Inc.), and the ten-point average roughness (Rz) can be measured by a method conforming to JIS B0601:2001.

In the present embodiment, both the first separator surface 13a and the second separator surface 13b may have a ten-point average roughness (Rz) of greater than or equal to 2.7 μm. However, for example, in consideration of ease of process and the like, only one of the first separator surface 13a and the second separator surface 13b preferably has a ten-point average roughness (Rz) of greater than or equal to 2.7 μm, and only the first separator surface 13a more preferably has a ten-point average roughness (Rz) of greater than or equal to 2.7 μm.

The ten-point average roughness (Rz) of at least one of the first separator surface 13a and the second separator surface 13b is greater than or equal to 2.7 μm, preferably greater than or equal to 3.0 and less than or equal to 10, and more preferably greater than or equal to 3.5 and less than or equal to 8 from the viewpoint of suppressing an increase in battery resistance.

Hereinafter, an example of a configuration of a separator having a separator surface having a ten-point average roughness of greater than or equal to 2.7 μm will be described in detail.

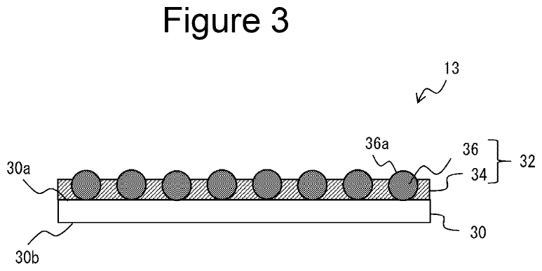

FIG. 3 is a schematic cross-sectional view illustrating an example of the separator according to the present embodiment. As illustrated in FIG. 3, the separator 13 includes a base material 30 having a first surface 30a and a second surface 30b, and a functional layer 32 disposed on the first surface 30a of the base material 30. The functional layer 32 may be disposed on the first surface 30a and the second surface 30b.

The base material 30 is, for example, a porous sheet having ion permeability and insulating properties, and specific examples thereof include a microporous thin film, a woven fabric, and a nonwoven fabric. The material of the base material 30 is not particularly limited, and examples thereof include polyolefins such as polyethylene, polypropylene, a copolymer of polyethylene and an α-olefin, acrylic resins, polystyrene, polyester, cellulose, polyimide, polyphenylene sulfide, polyether ether ketone, and a fluororesin.

The functional layer 32 includes a heat-resistant layer 34 containing inorganic particles and resin particles 36 dispersed in the heat-resistant layer 34. A part of the resin particles 36 forms projections 36a protruding from a surface of the heat-resistant layer 34. An outer surface of the functional layer 32, that is, a surface opposite to a surface facing the base material 30 is formed by the surface of the heat-resistant layer 34 and the projections 36a protruding from the surface of the heat-resistant layer 34. The outer surface of the functional layer 32 has a ten-point average roughness (Rz) of greater than or equal to 2.7 μm. For example, by increasing the average particle diameter (D50) of the resin particles 36 or increasing the amount of the resin particles 36 dispersed in the heat-resistant layer 34, the outer surface of the functional layer 32 is roughened, and the ten-point average roughness (Rz) is increased.

The outer surface of the functional layer 32 is the first separator surface 13a facing the positive electrode 11 or the second separator surface 13b facing the negative electrode 12 described above, and is preferably the first separator surface 13a facing the positive electrode 11.

The average particle diameter (D50) of the resin particles 36 is preferably larger than the average thickness of the heat-resistant layer 34 from the viewpoint of easily roughening the outer surface of the functional layer 32, and the difference between the average particle diameter (D50) of the resin particles 36 and the average thickness of the heat-resistant layer 34 is, for example, preferably greater than or equal to 0.5 μm and more preferably greater than or equal to 1.0 μm. The upper limit of the difference between the average particle diameter (D50) of the resin particles 36 and the thickness of the heat-resistant layer 34 is not particularly limited, but is, for example, desirably less than or equal to 10 μm and more desirably less than or equal to 5 μm from the viewpoint of decreasing the ion conductivity of the separator. The average particle diameter (D50) of the resin particles 36 depends on the thickness of the heat-resistant layer 34, but is preferably, for example, in a range of greater than or equal to 1.0 μm and less than or equal to 8.0 μm. In the present specification, D50 means a particle diameter at which a cumulative frequency in a volume-based particle size distribution is 50% from the smallest particle diameter, and is also referred to as a median diameter. The particle size distribution of the resin particles 36 can be measured by a laser diffraction type particle size distribution measuring apparatus (for example, MT3000II manufactured by MicrotracBEL Corp.) using water as a dispersion medium. The average thickness of the heat-resistant layer 34 is a value obtained by cutting the separator 13 along a plane perpendicular to the plane direction thereof, measuring the thicknesses of the heat-resistant layer 34 at 10 or greater points in the cross section, and averaging the measured thicknesses.

The content of the resin particles 36 is more preferably, for example, in a range of 4:96 to 20:80 in terms of a mass ratio of the resin particles 36 to the heat-resistant layer 34 (resin particles:heat-resistant layer).

The area occupancy of the resin particles 36 when the surface of the functional layer 32 is viewed in plan view is preferably greater than or equal to 2% and less than or equal to 30%, and more preferably greater than or equal to 10% and less than or equal to 25% from the viewpoint of roughening the outer surface of the functional layer 32. The area occupancy of the resin particles 36 can be calculated by observing the surface of the functional layer 32 with a scanning electron microscope and measuring the total area of the projections 36a present in a range of 100 μm×100 μm.

As the resin particles 36, for example, a known polymer that can be used as a binder when the functional layer 32 is formed can be used. Examples of a monomer unit constituting the resin particle 36 (polymer) include an aromatic vinyl monomer unit, a (meth)acrylic acid ester monomer unit, and a fluorine-containing monomer unit. In the present disclosure, “(meth)acrylic” means acrylic and/or methacrylic. The resin particles 36 (polymer) “containing monomer units” means that the polymer obtained using a monomer contains repeating units derived from the monomer.

Examples of an aromatic vinyl monomer capable of forming the aromatic vinyl monomer unit are not particularly limited, and include styrene, α-methylstyrene, styrenesulfonic acid, butoxystyrene, and vinylnaphthalene. Examples of a (meth)acrylic acid ester monomer capable of forming the (meth)acrylic acid ester monomer unit include: alkyl acrylates such as methyl acrylate, ethyl acrylate, n-propyl acrylate, isopropyl acrylate, butyl acrylates such as n-butyl acrylate and t-butyl acrylate, pentyl acrylate, hexyl acrylate, heptyl acrylate, octyl acrylates such as 2-ethylhexyl acrylate, nonyl acrylate, decyl acrylate, lauryl acrylate, n-tetradecyl acrylate, and stearyl acrylate; and alkyl methacrylate such as methyl methacrylate, ethyl methacrylate, n-propyl methacrylate, isopropyl methacrylate, butyl methacrylate such as n-butyl methacrylate and t-butyl methacrylate, pentyl methacrylate, hexyl methacrylate, heptyl methacrylate, octyl methacrylate such as 2-ethylhexyl methacrylate, nonyl methacrylate, decyl methacrylate, lauryl methacrylate, n-tetradecyl methacrylate, and stearyl methacrylate.

Examples of a fluorine-containing monomer capable of forming the fluorine-containing monomer unit are not particularly limited, and include vinylidene fluoride, tetrafluoroethylene, hexafluoropropylene, vinyl trifluoride chloride, vinyl fluoride, and perfluoroalkyl vinyl ether.

The resin particle 36 may contain a crosslinkable monomer unit in addition to the above-mentioned monomer unit. Here, the crosslinkable monomer unit is a monomer capable of forming a crosslinked structure during or after polymerization by heating or irradiation with energy rays. Examples of the monomers capable of forming crosslinkable monomer units include a polyfunctional monomer having two or greater polymerizable reactive groups in the monomer. Examples of the polyfunctional monomers include divinyl compounds such as allyl methacrylate and divinylbenzene; di(meth)acrylic acid ester compounds such as diethylene glycol dimethacrylate, ethylene glycol dimethacrylate, diethylene glycol diacrylate, and 1,3-butylene glycol diacrylate; tri(meth)acrylic acid ester compounds such as trimethylolpropane trimethacrylate and trimethylolpropane triacrylate; ethylenically unsaturated monomers containing epoxy groups such as allyl glycidyl ether and glycidyl methacrylate; and the like.

The resin particles 36 can be prepared, for example, by polymerizing a monomer composition containing the above-described monomer in an aqueous solvent such as water. The polymerization method is not particularly limited, and may be, for example, a suspension polymerization method, an emulsion polymerization aggregation method, a pulverization method, or the like. Further, as a polymerization reaction, any reaction such as radical polymerization or living radical polymerization can be used.

In the monomer composition used for preparing the resin particles 36, other compounding materials such as a chain transfer agent, a polymerization modifier, a polymerization reaction retarder, a reactive fluidizing agent, a filler, a flame retardant, an antiaging agent, and a colorant can be compounded in an arbitrary compounding amount.

Examples of the inorganic particles contained in the heat-resistant layer 34 include metal oxide particles, metal nitride particles, metal fluoride particles, and metal carbide particles.

Examples of the metal oxide particles include aluminum oxide, titanium oxide, magnesium oxide, zirconium oxide, nickel oxide, silicon oxide, and manganese oxide. Examples of the metal nitride particles include titanium nitride, boron nitride, aluminum nitride, magnesium nitride, and silicon nitride. Examples of the metal fluoride particles include aluminum fluoride, lithium fluoride, sodium fluoride, magnesium fluoride, calcium fluoride, and barium fluoride. Examples of the metal carbide particles include silicon carbide, boron carbide, titanium carbide, and tungsten carbide.

The inorganic particles may be porous aluminosilicates such as zeolite (M_{2/n}O·Al₂O₃·xSiO₂·yH₂O, M is a metal element, n is a valence of M, x≥2, and y≥0), layered silicates such as talc (Mg₃Si₄O₁₀(OH)₂), minerals such as barium titanate (BaTiO₃) and strontium titanate (SrTiO₃), and the like. Note that these may be used singly or in combination of two or greater kinds thereof.

The heat-resistant layer 34 preferably further contains a binder. The binder has a function of bonding the inorganic particles to each other and bonding the inorganic particles to the base material 30, for example. Examples of the binder include fluorine-based resins such as polyvinylidene fluoride (PVDF) and polytetrafluoroethylene (PTFE), polyimide-based resins, acryl-based resins, polyolefin-based resins, styrene-butadiene rubber (SBR), nitrile-butadiene rubber (NBR), carboxymethyl cellulose (CMC) or a salt thereof, and polyvinyl alcohol (PVA). These may be used singly or in combination of two or more kinds thereof. The content of the inorganic particles contained in the heat-resistant layer 34 is preferably, for example, greater than or equal to 400 mass % and less than or equal to 9900 mass % with respect to the mass of the binder. In addition, the content of the binder contained in the heat-resistant layer 34 is preferably, for example, greater than or equal to 3 mass % and less than or equal to 30 mass % with respect to the total mass of the heat-resistant layer 34.

The heat-resistant layer 34 preferably contains a binder and a polymer having an aramid bond. The polymer having the aramid bond has, for example, a function of improving the heat resistance of the heat-resistant layer 34. Examples of the polymer having the aramid bond include aromatic polyamides such as meta-oriented aromatic polyamide and para-oriented aromatic polyamide. The content of the inorganic particles contained in the heat-resistant layer 34 is, for example, preferably greater than or equal to 25 mass % and less than or equal to 900 mass % with respect to the total mass of the binder and the polymer having the aramid bond. The content of the binder contained in the heat-resistant layer 34 is preferably, for example, greater than or equal to 3 mass % and less than or equal to 30 mass % with respect to the total mass of the heat-resistant layer 34. The content of the heat-resistant polymer contained in the heat-resistant layer 34 is preferably, for example, greater than or equal to 10 mass % and less than or equal to 80 mass % with respect to the total mass of the heat-resistant layer 34.

An example of a method for producing the separator 13 of the present embodiment will be described. For example, a slurry composition for a functional layer is prepared by mixing inorganic particles, resin particles 36, water serving as a dispersion medium, and other components (for example, a binder, a polymer having an aramid bond, and the like) used as necessary. Then, functional layer slurry is applied onto the base material and then dried, so that the separator 13 of the present embodiment can be produced.

As another example of the separator 13 of the present embodiment, a separator includes a base material 30 having a first surface 30a and a second surface 30b, and a functional layer 32 disposed on the first surface 30a of the base material 30, in which the second surface 30b of the base material 30 has a ten-point average roughness (Rz) of greater than or equal to 2.7 μm, or the outer surface of the functional layer 32 and the second surface 30b of the base material 30 have a ten-point average roughness (Rz) of greater than or equal to 2.7 μm. The second surface 30b of the base material 30 may be the first separator surface 13a facing the positive electrode 11 or the second separator surface 13b facing the negative electrode 12. However, when only the second surface 30b of the base material 30 in the outer surface of the functional layer 32 and the second surface 30b of the base material 30 has a ten-point average roughness (Rz) of greater than or equal to 2.7 μm, the second surface 30b of the base material 30 is preferably the first separator surface 13a facing the positive electrode 11.

The separator 13 of the present embodiment is not limited to a separator having the base material 30 and the functional layer 32 disposed on the base material 30, and may include only the base material 30, for example. The functional layer 32 does not necessarily include the heat-resistant layer 34 containing inorganic particles. The functional layer 32 includes, for example, a layer containing a known additive, and examples of the layer other than the heat-resistant layer include an antistatic layer, an adhesive layer, a slipping layer, a leveling layer, a flame retardant layer, a layer that improves intimacy to an electrolytic solution, an antioxidant layer, and a softening layer.

When the separator 13 includes only the base material 30, at least one of the first surface 30a and the second surface 30b of the base material 30 has a ten-point average roughness (Rz) of greater than or equal to 2.7 μm. Examples of a method for roughening the surface of the base material 30 to adjust the ten-point average roughness (Rz) to greater than or equal to 2.7 μm include a method for mixing the resin particles 36 with a raw material of the base material 30 to produce the base material 30, and a method for embedding the resin particles 36 in the produced base material 30. In this case, the average particle diameter (D50) of the resin particles 36 is preferably larger than the thickness of the base material 30.

Examples of the method for adjusting the ten-point average roughness (Rz) of the surface of the separator to greater than or equal to 2.7 μm include a method for rolling the separator with a rolling roller having irregularities in addition to the use of the resin particles 36 described above. For example, after a layer such as the heat-resistant layer 34 is formed on the base material 30, a surface of the layer is rolled with a rolling roller having irregularities to adjust the ten-point average roughness (Rz) of the surface of the separator to greater than or equal to 2.7 μm.

### EXAMPLES

Hereinafter, the present disclosure will be further described with reference to Examples. However, the present disclosure is not limited to the following Examples.

### Comparative Example 1

### [Production of Positive Electrode]

A positive electrode mixture slurry was prepared by mixing 100 parts by mass of LiNi_{0.88}Co_{0.09}Al_{0.03}O₂, 1 part by mass of acetylene black (AB), and 0.9 parts by mass of polyvinylidene fluoride (PVDF), and adding an appropriate amount of N-methyl-2-pyrrolidone (NMP). Next, the positive electrode mixture slurry was applied to both surfaces of an aluminum foil (positive electrode current collector) having a thickness of 15.0 μm and a 1% elongation strength of 190 MPa, and the coating film was dried. Then, the coating film was rolled using a roller and then cut into a predetermined electrode size to produce a positive electrode having a positive electrode mixture layer formed on both surfaces of a positive electrode current collector. An exposed portion where the positive electrode mixture layer was not formed and the positive electrode current collector was exposed was provided at a central portion of the positive electrode in the longitudinal direction, and an aluminum positive electrode lead was welded to the exposed portion.

### [Production of Negative Electrode]

A negative electrode mixture slurry was prepared by mixing 95 parts by mass of graphite powder, 5 parts by mass of Si oxide, 1 part by mass of carboxymethylcellulose, and 1 part by mass of a dispersion of styrene-butadiene rubber (SBR), and adding an appropriate amount of water thereto. Next, the negative electrode mixture slurry was applied to both surfaces of a copper foil (negative electrode current collector) having a thickness of 7.8 μm and a 1% elongation strength of 550 MPa, and the coating film was dried. Then, the coating film was rolled using a roller and then cut into a predetermined electrode size to produce a negative electrode having a negative electrode mixture layer formed on both surfaces of a negative electrode current collector. An exposed portion where the negative electrode mixture layer was not formed and the negative electrode current collector was exposed was provided at one end portion of the negative electrode in the longitudinal direction (an end portion located on the wound inner side of the electrode assembly), and a nickel negative electrode lead was welded to the exposed portion.

### [Production of Separator]

A porous base material made of polyethylene having a thickness of 12 μm was prepared. The α-Al₂O₃ powder (inorganic particles) and the binder were mixed at a solid content mass ratio of 75:25, and then an appropriate amount of water was added to prepare a functional layer slurry. A separator in which a functional layer including a heat-resistant layer having an average thickness of 3 μm was formed on one surface of the base material was obtained by applying the functional layer slurry onto the entire area of one surface of the base material using a microgravure coater, and heating and drying the coating film in an oven at 50 °C for 4 hours.

The ten-point average roughness (Rz) of the outer surface of the functional layer was measured and found to be 2.2 μm.

### [Production of Electrode Assembly]

A wound electrode assembly was produced by spirally winding the positive electrode and the negative electrode with the separator interposed therebetween. At this time, the separator was disposed such that the functional layer of the separator faced the positive electrode.

### [Preparation of Non-Aqueous Electrolyte]

A non-aqueous electrolyte was prepared by adding 5 parts by mass of vinylene carbonate (VC) to 100 parts by mass of a mixed solvent obtained by mixing ethylene carbonate (EC) and dimethyl carbonate (DMC) at a volume ratio of 3:7, and dissolving lithium hexafluorophosphate (LiPF₆) therein at a concentration of 1.5 mol/liter.

### [Production of Secondary Battery]

Insulating plates were respectively arranged above and below the electrode assembly, and the electrode assembly was housed in an exterior can. The negative electrode lead was welded to a bottom of a bottomed cylindrical exterior can, and the positive electrode lead was welded to a sealing assembly. A secondary battery was produced by sealing the opening of the exterior can with the sealing assembly through the gasket after injecting a non-aqueous electrolyte into the exterior can, and then leaving the exterior can in a thermostatic chamber at 60 °C for 15 hours.

### Comparative Example 2

A secondary battery was produced in the same manner as in Comparative Example 1 except that a copper foil having a thickness of 7.8 μm and a 1% elongation strength of 300 MPa was used for the negative electrode current collector.

### Comparative Example 3

A secondary battery was produced in the same manner as in Comparative Example 1 except that a copper foil having a thickness of 7.8 μm and a 1% elongation strength of 200 MPa was used for the negative electrode current collector.

### Comparative Example 4

A secondary battery was produced in the same manner as in Comparative Example 1 except that an aluminum foil having a thickness of 15.0 μm and a 1% elongation strength. of 120 MPa was used for the positive electrode current collector.

### Comparative Example 5

A secondary battery was produced in the same manner as in Comparative Example 1 except that an aluminum foil having a thickness of 15.0 μm and a 1% elongation strength of 58 MPa was used for the positive electrode current collector.

### COMPARATIVE EXAMPLE

A secondary battery was produced in the same manner as in Comparative Example 1 except that an aluminum foil having a thickness of 15.0 μm and a 1% elongation strength of 58 MPa was used for the positive electrode current collector, and a copper foil having a thickness of 7.8 μm and a 1% elongation strength of 200 MPa was used for the negative electrode current collector.

### Comparative Example 7

A secondary battery was produced in the same manner as in Comparative Example 1 except that an α-Al₂O₃ powder, a binder, and acrylic resin particles having an average particle diameter (D50) of 3.5 μm were mixed at a solid content mass ratio of 70.6:23.5:5.9 in the preparation of a slurry for a functional layer.

When the surface of the functional layer of the separator obtained in Comparative Example 7 was observed with a scanning electron microscope, a plurality of projections in which a part of the acrylic resin particles protruded from the heat-resistant layer were confirmed. In other Comparative Examples and Examples containing the acrylic resin particles described below, a plurality of projections were similarly confirmed.

The difference between the average particle diameter (D50) of the acrylic resin particles and the average thickness (Db) of the heat-resistant layer was 0.5 μm. In addition, as a result of measuring the ten-point average roughness (Rz) of the outer surface of the functional layer, it was found to be 2.7 μm.

### Comparative Example 8

A secondary battery was produced in the same manner as in Comparative Example 1 except that an aluminum foil having a thickness of 15.0 μm and a 1% elongation strength of 120 MPa was used for the positive electrode current collector, a copper foil having a thickness of 7.8 μm and a 1% elongation strength of 300 MPa was used for the negative electrode current collector, and in the preparation of the functional layer slurry, an α-Al₂O₃ powder, a binder, and acrylic resin particles having an average particle diameter (D50) of 5.0 μm were mixed at a solid content mass ratio of 68.9:22.9:8.2.

The difference between the average particle diameter (D50) of the acrylic resin particles and the average thickness (Db) of the heat-resistant layer was 2 μm. In addition, as a result of measuring the ten-point average roughness (Rz) of the outer surface of the functional layer, it was found to be 2.7 μm.

### <Battery Evaluation>

Under an environmental temperature of 25 °C, the secondary battery of each Comparative Example was charged to a voltage of 4.2 V at a constant current of 0.2 It, and then charged at 4.2 V until a current value reached 0.02 It. Thereafter, the battery was discharged to a voltage of 3.0 V at a constant current of 0.2 It. The charging and discharging was defined as one cycle, and 300 cycles were performed.

The secondary battery after 300 cycles was charged to 3.7 V, the voltage was held at 3.7 V for 1 hour, and the battery resistance after 300 cycles was calculated from the voltage drop amount after 5 seconds when the secondary battery was discharged at 4.8 mA.

An X-ray image of the secondary battery after 300 cycles was photographed, and when bending was confirmed in the positive electrode and the negative electrode of the electrode assembly, it was evaluated that buckling occurred, and when bending was not confirmed in the positive electrode and the negative electrode of the electrode assembly, it was evaluated that buckling did not occur. The number of test samples was 20.

Table 1 summarizes results of the evaluation on the occurrence of buckling of the electrode assembly and the battery resistance in Comparative Examples 1 to 6. However, a value of the battery resistance is indicated by relative values of Comparative Examples 2 to 6 with the result of Comparative Example 1 as a reference (100).

TABLE 1

| | Positive electrode current collector | | | Negative electrode current collector | | | | | | |
|---|---|---|---|---|---|---|---|---|---|---|
| | 1% | | | 1% | | | | | | |
| | Elongation | | | Elongation | | | Separator | | Results | |
| | strength CM | Thickness | CM × | strength CM | Thickness | CM × | D50 − | Rz | | Battery |
| | (MPa) | CT (μm) | CT | (MPa) | CT (μm) | CT | Db (μm) | (μm) | Buckling | resistance |
| Comparative | 190 | 15 | 2850 | 550 | 7.8 | 4290 | — | 2.2 | Occurrence | 100 |
| Example 1 | | | | | | | | | | |
| Comparative | 190 | 15 | 2850 | 300 | 7.8 | 2340 | — | 2.2 | Occurrence | 100 |
| Example 2 | | | | | | | | | | |
| Comparative | 190 | 15 | 2850 | 200 | 7.8 | 1560 | — | 2.2 | Non- | 120 |
| Example 3 | | | | | | | | | occurrence | |
| Comparative | 120 | 15 | 1800 | 550 | 7.8 | 4290 | — | 2.2 | Occurrence | 100 |
| Example 4 | | | | | | | | | | |
| Comparative | 58 | 15 | 870 | 550 | 7.8 | 4290 | — | 2.2 | Non- | 115 |
| Example 5 | | | | | | | | | occurrence | |
| Comparative | 58 | 15 | 870 | 200 | 7.8 | 1560 | — | 2.2 | Non- | 130 |
| Example 6 | | | | | | | | | occurrence | |
| Comparative | 190 | 15 | 2850 | 550 | 7.8 | 4290 | 0.5 | 2.7 | Occurrence | 100 |
| Example 7 | | | | | | | | | | |
| Comparative | 120 | 15 | 1800 | 300 | 7.8 | 2340 | 2 | 4.7 | Occurrence | 100 |
| Example 8 | | | | | | | | | | |

As can be seen from the results in Table 1, in Comparative Examples 1, 2, 4, 7, and 8 in which both the positive electrode current collector and the negative electrode current collector did not satisfy a relationship of CM×CT≤1700, buckling of the electrode assembly occurred. In Comparative Examples 3, 5, and 6 in which the positive electrode current collector or the negative electrode current collector satisfied the relationship of CM×CT≤1700, and the separator surface (the outer surface of the functional layer) had a ten-point average roughness (Rz) of less than 2.7 μm, buckling of the electrode assembly did not occur, but the battery resistance increased as compared with Comparative Example 1.

### Comparative Example 9

A secondary battery was produced in the same manner as in Comparative Example 1 except that a copper foil having a thickness of 7.8 μm and a 1% elongation strength of 200 MPa was used for the negative electrode current collector, and in the preparation of the functional layer slurry, an α-Al₂O₃ powder, a binder, and acrylic resin particles having an average particle diameter (D50) of 3.1 μm were mixed at a solid content mass ratio of 71.0:23.7:5.3, and the same test was performed.

The difference between the average particle diameter (D50) of the acrylic resin particles and the average thickness (Db) of the heat-resistant layer was 0.1 μm. In addition, as a result of measuring the ten-point average roughness (Rz) of the outer surface of the functional layer, it was found to be 2.3 μm.

### Comparative Example 10

A secondary battery was produced in the same manner as in Comparative Example 1 except that a copper foil having a thickness of 7.8 μm and a 1% elongation strength of 200 MPa was used for the negative electrode current collector, and in the preparation of the functional layer slurry, an α-Al₂O₃ powder, a binder, and acrylic resin particles having an average particle diameter (D50) of 3.3 μm were mixed at a solid content mass ratio of 71.0:23.6:5.4, and the same test was performed.

The difference between the average particle diameter (D50) of the acrylic resin particles and the average thickness (Db) of the heat-resistant layer was 0.3 μm. In addition, as a result of measuring the ten-point average roughness (Rz) of the outer surface of the functional layer, it was found to be 2.4 μm.

### Example 1

A secondary battery was produced in the same manner as in Comparative Example 1 except that a copper foil having a thickness of 7.8 μm and a 1% elongation strength of 200 MPa was used for the negative electrode current collector, and in the preparation of the functional layer slurry, mixing was performed under the same conditions as in Comparative Example 7, and the same test was performed.

The difference between the average particle diameter (D50) of the acrylic resin particles and the average thickness (Db) of the heat-resistant layer was 0.5 μm. In addition, as a result of measuring the ten-point average roughness (Rz) of the outer surface of the functional layer, it was found to be 2.7 μm.

### Example 2

A secondary battery was produced in the same manner as in Comparative Example 1 except that a copper foil having a thickness of 7.8 μm and a 1% elongation strength of 200 MPa was used for the negative electrode current collector, and in the preparation of the functional layer slurry, an α-Al₂O₃ powder, a binder, and acrylic resin particles having an average particle diameter (D50) of 4.0 μm were mixed at a solid content mass ratio of 70.0:23.3:6.7, and the same test was performed.

The difference between the average particle diameter (D50) of the acrylic resin particles and the average thickness (Db) of the heat-resistant layer was 1 μm. In addition, as a result of measuring the ten-point average roughness (Rz) of the outer surface of the functional layer, it was found to be 3.4 μm.

### Example 3

A secondary battery was produced in the same manner as in Comparative Example 1 except that a copper foil having a thickness of 7.8 μm and a 1% elongation strength of 200 MPa was used for the negative electrode current collector, and in the preparation of the functional layer slurry, mixing was performed under the same conditions as in Comparative Example 8, and the same test was performed.

The difference between the average particle diameter (D50) of the acrylic resin particles and the average thickness (Db) of the heat-resistant layer was 2 μm. In addition, as a result of measuring the ten-point average roughness (Rz) of the outer surface of the functional layer, it was found to be 4.7 μm.

### Example 4

A secondary battery was produced in the same manner as in Comparative Example 1 except that a copper foil having a thickness of 7.8 μm and a 1% elongation strength of 200 MPa was used for the negative electrode current collector, and in the preparation of the functional layer slurry, an α-Al₂O₃ powder, a binder, and acrylic resin particles having an average particle diameter (D50) of 8.0 μm were mixed at a solid content mass ratio of 65.6:21.8:12.6, and the same test was performed.

The difference between the average particle diameter (D50) of the acrylic resin particles and the average thickness (Db) of the heat-resistant layer was 5 μm. In addition, as a result of measuring the ten-point average roughness (Rz) of the outer surface of the functional layer, it was found to be 7.8 μm.

Table 2 summarizes results of the evaluation on the occurrence of buckling of the electrode assembly and the battery resistance in Comparative Examples 9 and 10 and Examples 1 to 4. However, a value of the battery resistance is indicated by relative values of Comparative Examples 9 and 10 and Examples 1 to 4 with the result of Comparative Example 1 as a reference (100).

TABLE 2

| | Positive electrode current | | | Negative electrode current | | | | | | |
|---|---|---|---|---|---|---|---|---|---|---|
| | collector | | | collector | | | | | | |
| | 1% | | | 1% | | | | | | |
| | Elongation | | | Elongation | | | Separator | | Results | |
| | strength CM | Thickness | CM × | strength CM | Thickness | CM × | D50 − Db | Rz | | Battery |
| | (MPa) | CT (μm) | CT | (MPa) | CT (μm) | CT | (μm) | (μm) | Buckling | resistance |
| Comparative | 190 | 15 | 2850 | 200 | 7.8 | 1560 | 0.1 | 2.3 | Non- | 118 |
| Example 9 | | | | | | | | | occurrence | |
| Comparative | 190 | 15 | 2850 | 200 | 7.8 | 1560 | 0.3 | 2.4 | Non- | 115 |
| Example 10 | | | | | | | | | occurrence | |
| Example 1 | 190 | 15 | 2850 | 200 | 7.8 | 1560 | 0.5 | 2.7 | Non- | 100 |
| | | | | | | | | | occurrence | |
| Example 2 | 190 | 15 | 2850 | 200 | 7.8 | 1560 | 1 | 3.4 | Non- | 98 |
| | | | | | | | | | occurrence | |
| Example 3 | 190 | 15 | 2850 | 200 | 7.8 | 1560 | 2 | 4.7 | Non- | 98 |
| | | | | | | | | | occurrence | |
| Example 4 | 190 | 15 | 2850 | 200 | 7.8 | 1560 | 5 | 7.8 | Non- | 98 |
| | | | | | | | | | occurence | |

As can be seen from the results in Table 2, in Comparative Examples 9 and 10 in which the relationship of CM×CT≤1700 was satisfied in the negative electrode current collector, and the separator surface (outer surface of the functional layer) had a ten-point average roughness (Rz) of less than 0.7 μm, buckling of the electrode assembly did not occur, but the battery resistance increased as compared with Comparative Example 1. On the other hand, in Examples 1 to 4 in which the relationship of CM×CT≤1700 was satisfied in the negative electrode current collector, and the separator surface (outer surface of the functional layer) had a ten-point average roughness (Rz) of greater than or equal to 2.7 μm, buckling of the electrode assembly did not occur, and the battery resistance was equivalent to that of Comparative Example 1. That is, it can be said that an increase in battery resistance was suppressed in Examples 1 to 4.

### Comparative Example 11

A secondary battery was produced in the same manner as in Comparative Example 1 except that an aluminum foil having a thickness of 15.0 μm and a 1% elongation strength of 58 MPa was used for the positive electrode current collector, and the same functional layer slurry as in Comparative Example 9 was used, and the same test was performed.

### Comparative Example 12

A secondary battery was produced in the same manner as in Comparative Example 1 except that an aluminum foil having a thickness of 15.0 μm and a 1% elongation strength of 58 MPa was used for the positive electrode current collector, and the same functional layer slurry as in Comparative Example 10 was used, and the same test was performed.

### Example 5

A secondary battery was produced in the same manner as in Comparative Example 1 except that an aluminum foil having a thickness of 15.0 μm and a 1% elongation strength of 58 MPa was used for the positive electrode current collector, and the same functional layer slurry as in Example 1 was used, and the same test was performed.

### Example 6

A secondary battery was produced in the same manner as in Comparative Example 1 except that an aluminum foil having a thickness of 15.0 μm and a 1% elongation strength of 58 MPa was used for the positive electrode current collector, and the same functional layer slurry as in Example 2 was used, and the same test was performed.

### Example 7

A secondary battery was produced in the same manner as in Comparative Example 1 except that an aluminum foil having a thickness of 15.0 μm and a 1% elongation strength of 58 MPa was used for the positive electrode current collector, and the same functional layer slurry as in Example 3 was used, and the same test was performed.

### Example 8

A secondary battery was produced in the same manner as in Comparative Example 1 except that an aluminum foil having a thickness of 15.0 μm and a 1% elongation strength of 58 MPa was used for the positive electrode current collector, and the same functional layer slurry as in Example 4 was used, and the same test was performed.

### Example 9

A secondary battery was produced in the same manner as in Comparative Example 1 except that an aluminum foil having a thickness of 15.0 μm and a 1% elongation strength of 58 MPa was used for the positive electrode current collector, a copper foil having a thickness of 7.8 μm and a 1% elongation strength of 200 MPa was used for the negative electrode current collector, and the same functional layer slurry as in Example 4 was used, and the same test was performed.

Table 3 summarizes results of the evaluation on the occurrence of buckling of the electrode assembly and the battery resistance in Comparative Examples 11 and 12 and Examples 5 to 9. However, a value of the battery resistance is indicated by relative values of Comparative Examples 11 and 12 and Examples 5 to 9 with the result of Comparative Example 1 as a reference (100).

TABLE 3

| | Positive electrode current collector | | | Negative electrode current collector | | | | | | |
|---|---|---|---|---|---|---|---|---|---|---|
| | 1% | | | 1% | | | | | | |
| | Elongation | | | Elongation | | | Separator | | Results | |
| | strength CM | Thickness | CM × | strength CM | Thickness | CM × | D50 − | Rz | | Battery |
| | (MPa) | CT (μm) | CT | (MPa) | CT (μm) | CT | Db (μm) | (μm) | Buckling | resistance |
| Comparative | 58 | 15 | 870 | 550 | 7.8 | 4290 | 0.1 | 2.3 | Non- | 114 |
| Example 11 | | | | | | | | | occurrence | |
| Comparative | 58 | 15 | 870 | 550 | 7.8 | 4290 | 0.3 | 2.4 | Non- | 110 |
| Example 12 | | | | | | | | | occurence | |
| Example 5 | 58 | 15 | 870 | 550 | 7.8 | 4290 | 0.5 | 2.7 | Non- | 100 |
| | | | | | | | | | occurrence | |
| Example 6 | 58 | 15 | 870 | 550 | 7.8 | 4290 | 1 | 3.4 | Non- | 99 |
| | | | | | | | | | occurrence | |
| Example 7 | 58 | 15 | 870 | 550 | 7.8 | 4290 | 2 | 4.7 | Non- | 99 |
| | | | | | | | | | occurrence | |
| Example 8 | 58 | 15 | 870 | 550 | 7.8 | 4290 | 5 | 7.8 | Non- | 99 |
| | | | | | | | | | occurrence | |
| Example 9 | 58 | 15 | 870 | 200 | 78 | 1560 | 5 | 7.8 | Non- | 100 |
| | | | | | | | | | occurrence | |

As can be seen from the results in Table 3, in Comparative Examples 11 and 12 in which the relationship of CM×CT≤1700 was satisfied in the positive electrode current collector, and the separator surface (outer surface of the functional layer) had a ten-point average roughness (Rz) of less than 2.7 μm, buckling of the electrode assembly did not occur, but the battery resistance increased as compared with Comparative Example 1. On the other hand, in Examples 5 to 8 in which the relationship of CM×CT≤1700 was satisfied in the positive electrode current collector, and the separator surface (outer surface of the functional layer) had a ten-point average roughness (Rz) of greater than or equal to 2.7 μm, buckling of the electrode assembly did not occur, and the battery resistance was equivalent to that of Comparative Example 1. That is, it can be said that an increase in battery resistance was suppressed in Examples 5 to 8. In Example 9 in which both the positive electrode current collector and the negative electrode current collector satisfied the relationship of CM×CT≤1700, and the separator surface (the outer surface of the functional layer) had a ten-point average roughness (Rz) of greater than or equal to 2.7 μm, buckling of the electrode assembly did not occur, and an increase in battery resistance was also suppressed.

### Supplementary Notes

(1)

A secondary battery including:
an electrode assembly having a positive electrode, a negative electrode, and a separator provided between the positive electrode and the negative electrode, wherein
the positive electrode has a positive electrode current collector and a positive electrode mixture layer disposed on the positive electrode current collector,
the negative electrode has a negative electrode current collector and a negative electrode mixture layer disposed on the negative electrode current collector,
the negative electrode mixture layer has a negative electrode active material including a Si-containing material,
at least one of the positive electrode current collector and the negative electrode current collector satisfies a relationship CM×CT≤1700, the 1% elongation strength of the current collector being CM (MPa) and the average thickness of the current collector being CT (μm), and
the separator has a first separator surface facing the positive electrode and a second separator surface facing the negative electrode, and at least one of the first separator surface and the second separator surface has a ten-point average roughness (Rz) of greater than or equal to 2.7 μm.
   (2)

The secondary battery according to (1), wherein the first separator surface facing the positive electrode has a ten-point average roughness (Rz) of greater than or equal to 2.7 μm.

(3)

The secondary battery according to (1) or (2), wherein the average thickness CT of the current collector is in a range of greater than or equal to 5.0 μm and less than or equal to 25.0 μm.

(4)

The secondary battery according to any one of (1) to (3), wherein
the separator has a base material having a first surface and a second surface opposite to the first surface, and a functional layer disposed on at least the first surface of the base material between the first surface and the second surface, and
an outer surface of the functional layer is the first separator surface facing the positive electrode or the second separator surface facing the negative electrode, and has a ten-point average roughness (Rz) of greater than or equal to 0.7 μm.
   (5)

The secondary battery according to (4), wherein the outer surface of the functional layer is the first separator surface facing the positive electrode.

(6)

The secondary battery according to (4) or (5), wherein
the functional layer includes a heat-resistant layer containing inorganic particles and resin particles dispersed in the heat-resistant layer, and
a part of the resin particles forms projections protruding from a surface of the heat-resistant layer.
   (7)

The secondary battery according to (6), wherein a difference between an average particle diameter (D50) of the resin particles and an average thickness of the heat-resistant layer is greater than or equal to 0.5 μm.

(8)

The secondary battery according to (6) or (7), wherein an area occupancy of the resin particles when a surface of the functional layer is viewed in plan view is greater than or equal to 2% and less than or equal to 30%.

(9)

The secondary battery according to any one of (6) to (8), wherein the heat-resistant layer includes a binder, and a content of the inorganic particles is greater than or equal to 400 mass % and less than or equal to 9900 mass % with respect to a mass of the binder.

(10)

The secondary battery according to any one of (6) to (8), wherein the heat-resistant layer includes a binder and a polymer having an aramid bond, and a content of the inorganic particles is greater than or equal to 25 mass % and less than or equal to 900 mass % with respect to a total mass of the binder and the polymer having the aramid bond.

(11)

The secondary battery according to any one of (1) to (10), wherein a content of the Si-containing material is greater than or equal to 3 mass % with respect to a total mass of the negative electrode active material.

(12)

The secondary battery according to any one of (1) to (11), wherein
the separator has a base material having a first surface and a second surface opposite to the first surface, and a functional layer disposed on the first surface of the base material, and
the second surface of the base material is the first separator surface facing the positive electrode or the second separator surface facing the negative electrode, and has a ten-point average roughness (Rz) of greater than or equal to 2.7 μm.

### REFERENCE SIGNS LIST

10 Secondary battery
11 Positive electrode
12 Negative electrode
13 Separator
13a First separator surface
13b Second separator surface
14 Electrode assembly
15 Battery case
16 Case body
17 Sealing assembly
18, 19 Insulating plate
20 Positive electrode lead
21 Negative electrode lead
22 Projecting portion
23 Filter
24 Lower vent member
25 Insulating member
26 Upper vent member
27 Cap
28 Gasket
30 Base material
30a First surface
30b Second surface
32 Functional layer
34 Heat-resistant layer
36 Resin particles
36 Projections

1. A secondary battery comprising:
an electrode assembly having a positive electrode, a negative electrode, and a separator provided between the positive electrode and the negative electrode, wherein
the positive electrode has a positive electrode current collector and a positive electrode mixture layer disposed on the positive electrode current collector,
the negative electrode has a negative electrode current collector and a negative electrode mixture layer disposed on the negative electrode current collector,
the negative electrode mixture layer has a negative electrode active material including a Si-containing material,
at least one of the positive electrode current collector and the negative electrode current collector satisfies a relationship CM×CT≤1700, the 1% elongation strength of the current collector being CM (MPa) and the average thickness of the current collector being CT (μm), and
the separator has a first separator surface facing the positive electrode and a second separator surface facing the negative electrode, and at least one of the first separator surface and the second separator surface has a ten-point average roughness (Rz) of greater than or equal to 2.7 μm.

2. The secondary battery according to claim 1, wherein the first separator surface facing the positive electrode has a ten-point average roughness (Rz) of greater than or equal to 2.7 μm.

3. The secondary battery according to claim 1, wherein the average thickness CT of the current collector is in a range of greater than or equal to 5.0 μm and less than or equal to 25.0 μm.

4. The secondary battery according to claim 1, wherein
the separator has a base material having a first surface and a second surface opposite to the first surface, and a functional layer disposed on at least the first surface of the base material between the first surface and the second surface, and
an outer surface of the functional layer is the first separator surface facing the positive electrode or the second separator surface facing the negative electrode, and has a ten-point average roughness (Rz) of greater than or equal to 2.7 μm.

5. The secondary battery according to claim 4, wherein the outer surface of the functional layer is the first separator surface facing the positive electrode.

6. The secondary battery according to claim 4, wherein
the functional layer includes a heat-resistant layer containing inorganic particles and resin particles dispersed in the heat-resistant layer, and
a part of the resin particles forms projections protruding from a surface of the heat-resistant layer.

7. The secondary battery according to claim 6, wherein a difference between an average particle diameter (D50) of the resin particles and an average thickness of the heat-resistant layer is greater than or equal to 0.5 μm.

8. The secondary battery according to claim 6, wherein an area occupancy of the resin particles when a surface of the functional layer is viewed in plan view is greater than or equal to 2% and less than or equal to 30%.

9. The secondary battery according to claim 6, wherein the heat-resistant layer includes a binder, and a content of the inorganic particles is greater than or equal to 400 mass % and less than or equal to 9900 mass % with respect to a mass of the binder.

10. The secondary battery according to claim 6, wherein the heat-resistant layer includes a binder and a polymer having an aramid bond, and a content of the inorganic particles is greater than or equal to 25 mass % and less than or equal to 900 mass % with respect to a total mass of the binder and the polymer having the aramid bond.

11. The secondary battery according to claim 1, wherein a content of the Si-containing material is greater than or equal to 3 mass % with respect to a total mass of the negative electrode active material.

12. The secondary battery according to claim 1, wherein
the separator has a base material having a first surface and a second surface opposite to the first surface, and a functional layer disposed on the first surface of the base material, and
the second surface of the base material is the first separator surface facing the positive electrode or the second separator surface facing the negative electrode, and has a ten-point average roughness (Rz) of greater than or equal to 2.7 μm.
